(19) United States
(12) Patent Application Publication
(10) Pub. No.: US 2016/0130867 A1
(43) Pub. Date: May 12, 2016

(54) Window Shade Allowing Adjustment of the Amount of Incoming Light in Different Sections

(71) Applicant: Li-Ming Cheng, Kaohsiung City (TW)

(72) Inventor: Li-Ming Cheng, Kaohsiung City (TW)

(21) Appl. No.: 14/536,739

(22) Filed: Nov. 10, 2014

(51) Int. Cl. E06B 9/38

(52) U.S. Cl. CPC E06B 9/38; E06B 2009/2441

(57) ABSTRACT

A window shade includes an upper track, a lower track below the upper track, and front and rear connecting members. Two ends of each of the front and rear connecting members are respectively connected to the upper and lower tracks. A partitioning plate is mounted between the upper and lower tracks. Each of the front and rear connecting members strings the partitioning plate. A first curtain includes a first curtain body and a first weight. Two ends of the first curtain body are respectively connected to the upper track and the first weight. A second curtain includes a second curtain body and a second weight. Two ends of the second curtain body are respectively connected to the second weight and the partitioning plate. A separate adjustment module is connected to the upper track and strings the first and second weights for simultaneously pulling the first and second weights.

### BACKGROUND OF THE INVENTION

1. Field of the Invention

The present invention relates to a window shade and, more particularly, to a window shade allowing adjustment of the amount of incoming light in different sections.

2. Description of the Related Art

A type of Venetian blinds includes a plurality of parallel slats stringed by strings. An angle between each slat and a horizontal plane can be synchronously adjusted by rotating a control rod to adjust the amount of incoming light entering the indoor space. The upward movement extent of all slats from the bottom of the Venetian blind can be adjusted by a pull cord, such that the outdoor light can enter via the unshielded lower part of the window. An example of such a Venetian blind is disclosed in U.S. Pat. No. 2,802,243. However, Venetian blinds of this type do not allow adjustment of the amount of incoming light in different sections, leading to great limitation to adjustment of the indoor light.

FIG. 1 shows a conventional curtain assembly 9 including two curtain support columns 91 spaced from each other. Each of a first rod 92 and a second rod 93 has two ends respectively connected to the curtain support columns 91. The first rod 92 is connected to a third rod 95 by an upper curtain 94. The second rod 93 is connected to a fourth rod 97 and a fifth rod 98 via a lower curtain 96. A drive mechanism 99 includes two motors 991, wherein one of the motors 991 is coupled to and is capable of driving the third rod 95 via a drive shaft, and the other motor 991 is coupled to and is capable of driving the fourth rod 97 via another drive shaft. Thus, when the motors 911 of the drive mechanism 99 operate, the third rod 95 and the fourth rod 97 can roll up the upper curtain 94 and the lower curtain 96, such that the curtain assembly 9 can adjust the amount of incoming light in different sections. An example of such a curtain assembly 9 is disclosed in U.S. Pat. No. 6,860,310.

However, the curtain assembly 9 includes many components and has a complicated structure. Furthermore, each curtain requires a motor to control the folding or unfolding of the curtain. Thus, manufacturing the curtain assembly 9 is difficult and has a high cost, such that the installation is not easy and is not suitable to be proceeded by the user himself. As a result, the user must make an appointment with a professional worker to decide the time for installation, leading to inconvenience and incurring installation costs.

Furthermore, use of the curtain assembly 9 requires installation of the curtain support columns 91 on the ground of the place requiring the light-shielding effect, which is only suitable for a French window or a glass wall (usually used in a shopping mall or an office) spanning tens of meters but not suitable for a small-size window of a house.

Thus, improvement to conventional curtains is desired.

### SUMMARY OF THE INVENTION

An objective of the present invention is to provide a window shade allowing adjustment of the amount of incoming light in different sections, wherein the window shade is simple in structure and is easy to manufacture to thereby reduce the manufacturing costs while increasing installation convenience to permit installation by the user himself.

Another objective of the present invention is to provide a window shade allowing adjustment of the amount of incoming light in different sections, wherein the components of the window shade are simple and light, and wherein no curtain support columns are required in the place requiring the light-shielding effect, permitting use of the window shade on a small-size window of a house.

The present invention fulfills the above objectives by providing, in an aspect, a window shade including a track device. The track device includes an upper track, a lower track, a front connecting member, and a rear connecting member. The lower track is located below the upper track. The front connecting member includes two ends respectively connected to the upper track and the lower track. The rear connecting member includes two ends respectively connected to the upper track and the lower track. A partitioning plate is mounted between the upper track and the lower track. Each of the front connecting member and the rear connecting member strings the partitioning plate. A first curtain includes a first curtain body and a first weight. The first curtain body includes two ends respectively connected to the upper track and the first weight. A second curtain includes a second curtain body and a second weight. The second curtain body includes two ends respectively connected to the second weight and the partitioning plate. A separate adjustment module is connected to the upper track and strings the first weight and the second weight. The separate adjustment module is adapted for simultaneously pulling the first weight and the second weight.

The separate adjustment module can include a first stringing member, a first controller, and a speed changer. The first controller and the speed changer are mounted in the upper track. The first stringing member includes a first end fixed in the speed changer and a second end fixed to the second weight. The first stringing member strings the first weight and the second weight. The first controller includes a first follower having a first end indirectly connected to the first stringing member via the speed changer. The first follower further has a second end exposed outside of the upper track.

The window shade can further include a full-scale adjustment module having a second stringing member and a second controller. The second stringing member has a first end fixed in the speed changer and a second end fixed to the lower track. The second stringing member extends through the first weight, the partitioning plate, and the second weight. The second controller includes a second follower having a first end indirectly connected to the second stringing member via the speed changer. The second follower further has a second end exposed outside of the upper track.

The partitioning plate can include a plate body having a first lateral side and a second lateral side opposite to the first lateral side. The first lateral side has a first engagement groove facing the front connecting member. The second lateral side has a second engagement groove facing the rear connecting member. The front connecting member is a light-transmittable curtain. A portion of the front connecting member is inserted into the first engagement groove. A first fixing member is mounted in the first engagement groove to fix the portion of the front connecting member in the first engagement groove.

The rear connecting member can be a light-transmittable curtain. A portion of the rear connecting member is inserted into the second engagement groove. A second fixing member is mounted in the second engagement groove to fix the portion of the rear connecting member in the second engagement groove.

A bottom of the upper track can include a coupling portion. The first end of the first curtain body is connected to a top plate. The top plate is coupled with the coupling portion to connect the first curtain body to the upper track via the top plate.

In another aspect, a window shade includes a track device. The track device includes an upper track, a lower track, a front connecting member, and a rear connecting member. The lower track is located below the upper track in a vertical direction. The front connecting member includes two ends respectively connected to the upper track and the lower track. The rear connecting member includes two ends respectively connected to the upper track and the lower track. A plurality of partitioning plates is mounted between the upper track and the lower track. Each of the front connecting member and the rear connecting member strings the plurality of partitioning plates. The plurality of partitioning plates us spaced from each other in the vertical direction. A first curtain includes a first curtain body and a first weight. The first curtain body includes two ends respectively connected to the upper track and the first weight. A plurality of second curtains is provided. Each of the plurality of second curtains is mounted between two adjacent partitioning plates. Each of the plurality of second curtains includes a second curtain body and a second weight. Each second curtain body includes two ends respectively connected to the second weight and an upper one of the two adjacent partitioning plates. A separate adjustment module is connected to the upper track and strings the first weight and each second weight. The separate adjustment module is adapted for simultaneously pulling the first weight and each second weight.

The separate adjustment module can include a first stringing member, a first controller, and a speed changer. The first controller and the speed changer are mounted in the upper track. The first stringing member includes a first end fixed in the speed changer and a second end fixed to the lowest second weight. The first stringing member strings the first weight and each second weight. The first controller includes a first follower having a first end indirectly connected to the first stringing member via the speed changer. The first follower further has a second end exposed outside of the upper track.

The window shade can further include a full-scale adjustment module having a second stringing member and a second controller. The second stringing member has a first end fixed in the speed changer and a second end fixed to the lower track. The second stringing member extends through the first weight, the plurality of partitioning plates, and each second weight. The second controller includes a second follower having a first end indirectly connected to the second stringing member via the speed changer. The second follower further has a second end exposed outside of the upper track.

The present invention will become clearer in light of the following detailed description of illustrative embodiments of this invention described in connection with the drawings.

### BRIEF DESCRIPTION OF THE DRAWINGS

FIG. 1 is a perspective view of a conventional curtain assembly.

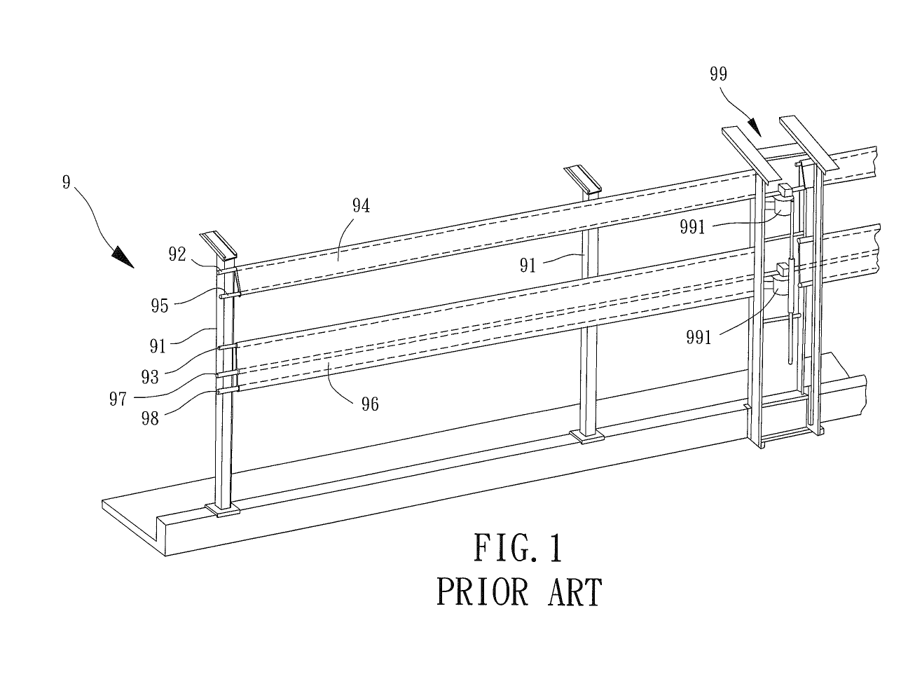

FIG. 2 is a perspective view of a window shade of a first embodiment according to the present invention.

FIG. 3 is a partial, perspective view of the window shade of FIG. 2.

FIG. 4 is a side view of the window shade of FIG. 2.

FIG. 5 is a view similar to FIG. 4, illustrating simultaneous folding of first and second curtains of the window shade of FIG. 2.

FIG. 6 is a perspective view similar to FIG. 2, illustrating incoming light through different sections of the window shade.

FIG. 7 is a side view of the window shade of FIG. 2 in a fully folded state.

FIG. 8 is a partial, exploded, perspective view of a window shade of a second embodiment according to the present invention.

FIG. 9 is a perspective view of the window shade of the second embodiment according to the present invention.

### DETAILED DESCRIPTION OF THE INVENTION

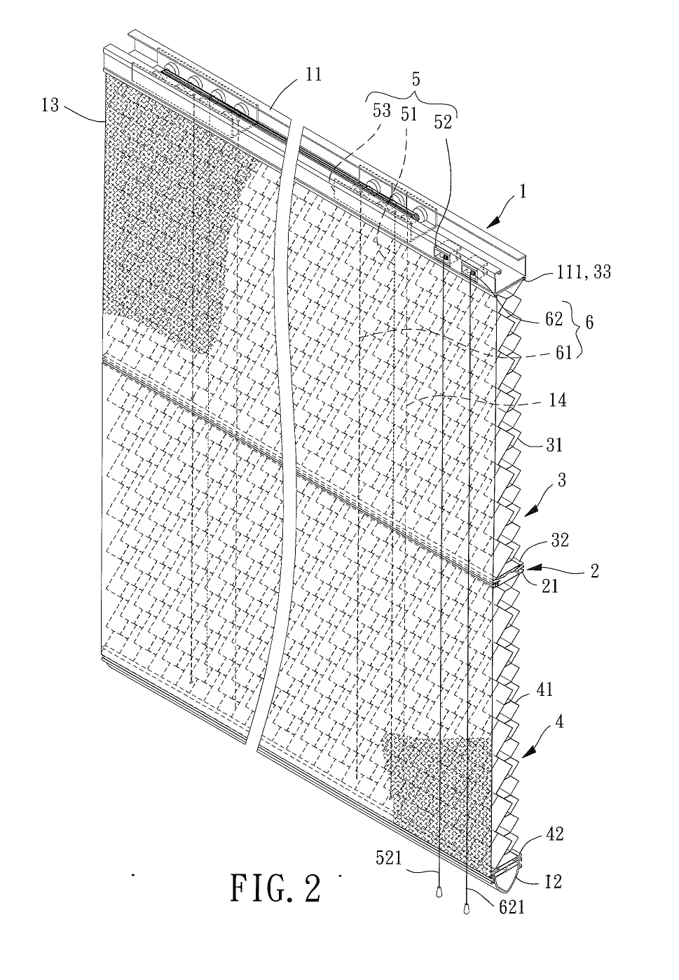

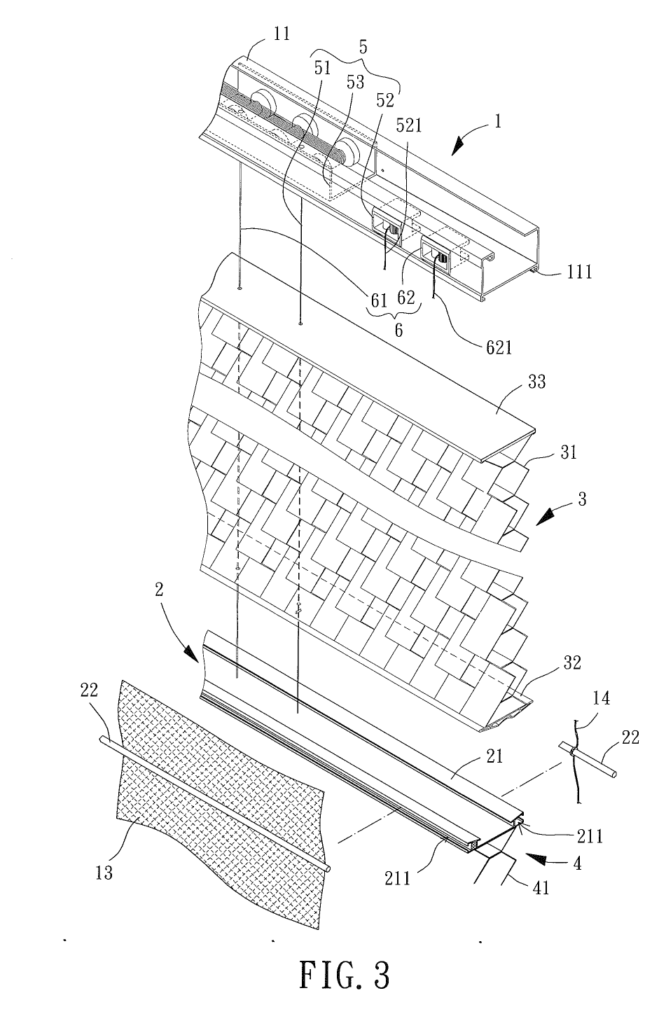

With reference to FIGS. 2 and 3, a window shade allowing adjustment of the amount of incoming light in different sections of a first embodiment according to the present invention includes a track device 1, a partitioning plate 2, a first curtain 3, a second curtain 4, and a separate adjustment module 5. The first curtain 3 and the second curtain 4 are connected to the track device 1 by the separate adjustment module 5. The partitioning plate 2 is mounted between the first curtain 3 and the second curtain 4.

The track device 1 includes an upper track 11, a lower track 12, a front connecting member 13, and a rear connecting member 14. The upper track 11 can be mounted to a top edge of a window. The first curtain 3 is connected to a bottom of the upper track 11. In a case that a light-shielding portion of the first curtain 3 cannot easily be attached to the bottom of the upper track 11 due to the material difference between the upper track 11 and the first curtain 3, a coupling portion 111 can be provided on the bottom of the upper track 11 for indirect connection with the light-shielding portion of the first curtain 3. In this embodiment, the coupling portion 111 includes two opposite guide rails. Each guide rail extends between two ends of the upper track 11 in a length direction.

The front connecting member 13 faces the indoor space. The rear connecting member 14 faces the window. The front connecting member 13 includes two ends respectively connected to the upper track 11 and the lower track 12. Likewise, the rear connecting member 14 includes two ends respectively connected to the upper track 11 and the lower track 12. Thus, the lower track 12 is stably suspended below the upper track 11 in a vertical direction. The front connecting member 13 and the rear connecting member 14 can be of any desired type capable of connecting the upper track 11 and the lower track 12, such as a light-transmittable curtain or a string. In a non-restrictive example of the first embodiment, the front connecting member 13 is a light-transmittable curtain (such as a screen net) that not only is transmittable to light but makes the light softer. Of more importance, the front connecting member 13 in the form of a light-transmittable curtain can avoid strangling of a child by the neck that occasionally occurs in the case of using a cord, providing enhanced use safety. Furthermore, in this embodiment, the rear connecting member 14 includes a plurality of strings.

The partitioning plate 2 is mounted between the upper track 11 and the lower track 12. Each of the front connecting member 13 and the rear connecting member 14 strings the partitioning plate 2. In this embodiment, the partitioning plate 2 includes a plate body 21 and first and second fixing members 22. The partitioning plate 2 includes a plate body 21 having a first lateral side and a second lateral side opposite to the first lateral side. The first lateral side has a first engagement groove 211 facing the front connecting member 13. The second lateral side has a second engagement groove 211 facing the rear connecting member 14.

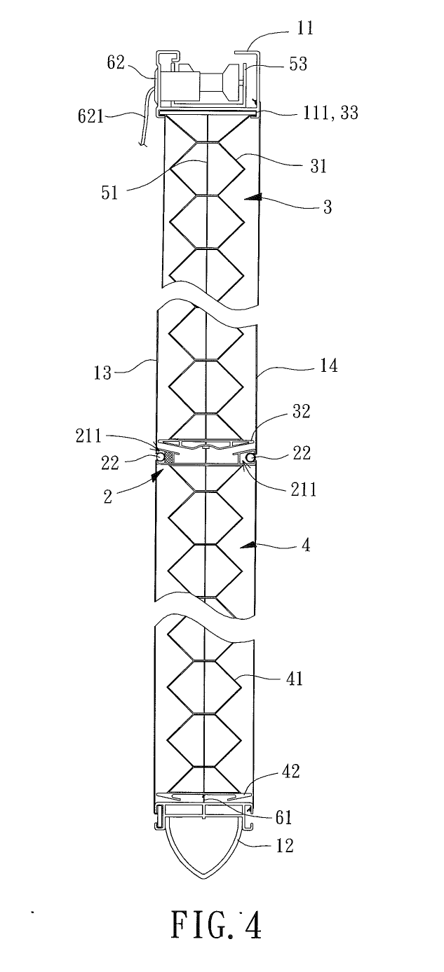

With reference to FIGS. 3 and 4, each of the first and second fixing members 22 can be a rod. A portion of the front connecting member 13 is inserted into the first engagement groove 211. The first fixing member 22 is mounted in the first engagement groove 211 to fix the portion of the front connecting member 13 in the first engagement groove 211. On the other hand, the rear connecting member 14 is tied to the second fixing member 22. The second fixing member 22 is mounted in the second engagement groove 211. Thus, the first and second lateral sides of the plate body 21 are fixed to the front connecting member 13 and the rear connecting member 14 to stably suspend the partitioning plate 2 between the upper track 11 and the lower track 12.

With reference to FIGS. 2 and 3, the first curtain 3 includes a first curtain body 31 and a first weight 32. The first curtain body 31 is the portion providing the light-shielding effect. The first curtain body 31 includes two ends respectively connected to the upper track 11 and the first weight 32. A spacing between the first weight 32 and the upper track 11 can be adjusted to control folding and unfolding of the first curtain body 31, achieving adjustment of the amount of incoming light. In this embodiment, the first end of the first curtain body 31 is connected to a top plate 33. The top plate 33 is coupled with the coupling portion 111 and is, thus, indirectly connected to the upper track 11.

Specifically, with reference to FIGS. 3 and 4, the top plate 33 is a thin, elongated plate. The first end of the upper track 11 is connected to a side of the top plate 33. In assembly, the other side of the top plate 33 not connected to the first curtain body 31 faces the upper track 11 and is placed into the coupling portion 111 via an end of the upper track 11. Thus, the top plate 33 is engaged in the coupling portion 111 to suspend the first curtain body 31 below the upper track 11 and to restrain the first curtain body 31 between the upper track 11 and the partitioning plate 2 and between the front connecting member 13 and the rear connecting member 14.

With reference to FIGS. 2 and 4, the second curtain 4 includes a second curtain body 41 and a second weight 42. The second curtain body 41 is the portion providing the light-shielding effect. The second curtain body 41 includes two ends respectively connected to the second weight 42 and the partitioning plate 2. A spacing between the second weight 42 and the partitioning plate 2 can be adjusted to control folding and unfolding of the second curtain body 41, achieving adjustment of the amount of incoming light. In this embodiment, the second curtain body 41 can be directly connected to a side of the partitioning plate 2 facing the lower track 12, such that the second curtain body 41 is suspended below the partitioning plate 2. Furthermore, the second curtain body 41 is restrained between the partitioning plate 2 and the lower track 12 and between the front connecting member 13 and the rear connecting member 14.

With reference to FIGS. 3 and 4, the separate adjustment module 5 is connected to the upper track 11 and strings the first weight 32 and the second weight 42. The separate adjustment module 5 is adapted for simultaneously pulling the first weight 32 and the second weight 42. In this embodiment, the separate adjustment module 5 includes a first stringing member 51, a first controller 52, and a speed changer 53. In a non-restrictive example, the stringing member 51 is a string. The first stringing member 51 includes a first end fixed in the speed changer 53. The first stringing member 51 strings the first weight 32 and the second weight 42 such that the first weight 32 and the second weight 42 can move synchronously. The first stringing member 51 further includes a second end fixed to the second weight 42.

The first controller 52 and the speed changer 53 are mounted in the upper track 11. The first controller 52 includes a first follower 521 having a first end indirectly connected to the first stringing member 51 via the speed changer 53. The first follower 521 further has a second end exposed outside of the upper track 11. The speed changer 53 can amplify the displacement of the follower 521 to the first stringing member 51 such that the user can easily control the displacement of the first stringing member 51. The speed changer 53 can be of a conventional design, and detailed structure of the speed changer 53 is not set forth herein to avoid redundancy, which can be appreciated by a person having ordinary skill in the art.

The number of the first stringing member 51 and the speed changer 53 can be increased according to need. In the embodiment shown in FIG. 2, a plurality of first stringing members 51 and a plurality of speed changers 53 are used. Thus, the force for pulling the first weight 32 and the second weight 42 can be more uniform. The first follower 521 strings the speed changers 53 to permit synchronous operation of the speed changers 53.

With reference to FIGS. 2 and 4, the window shade can further include a full-scale adjustment module 6. The full-scale adjustment module 6 includes a second stringing member 61 and a second controller 62. In a non-restrictive example, the second stringing member 61 is a string. The second stringing member 61 has a first end fixed in the speed changer 53. The second stringing member 61 extends through the first weight 32, the partitioning plate 2, and the second weight 42. The second stringing member 61 further has a second end fixed to the lower track 12.

The second controller 62 is also mounted in the upper track 11. The second controller 62 includes a second follower 621 having a first end indirectly connected to the second stringing member 61 via the speed changer 53. The second follower 621 further has a second end exposed outside of the upper track 11.

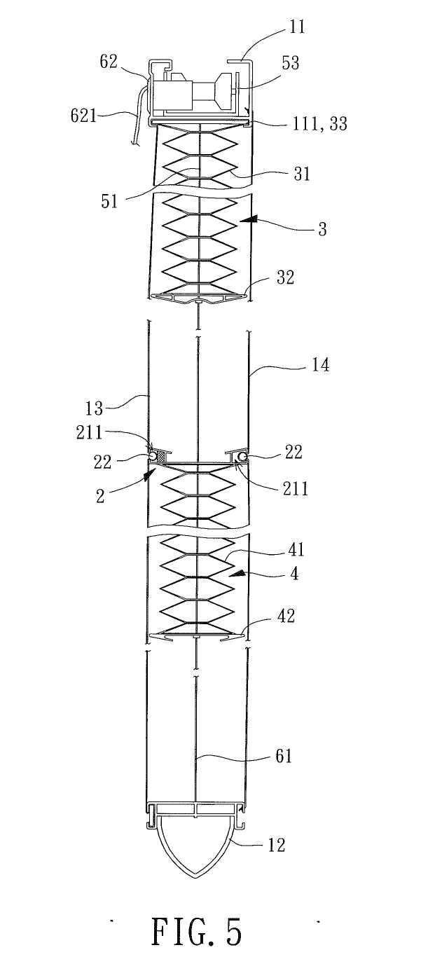

When the window shade is in a state shown in FIGS. 2 and 4, if the first stringing member 51 of the separate adjustment module 5 is pulled, the first weight 32 and the second weight 42 can synchronously be moved by the first stringing member 51. As can be seen from FIG. 5, the first weight 32 is moved upwards to reduce the spacing between the first weight 32 and the upper track 11. The first curtain body 31 is folded to permit the incoming light to enter the indoor space from between the first weight 32 and the partitioning plate 2. At the same time, the second weight 42 is also moved upwards to reduce the spacing between the second weight 42 and the partitioning plate 2. The second curtain body 42 is folded to permit the incoming light to enter the indoor space from between the second weight 42 and the lower track 12.

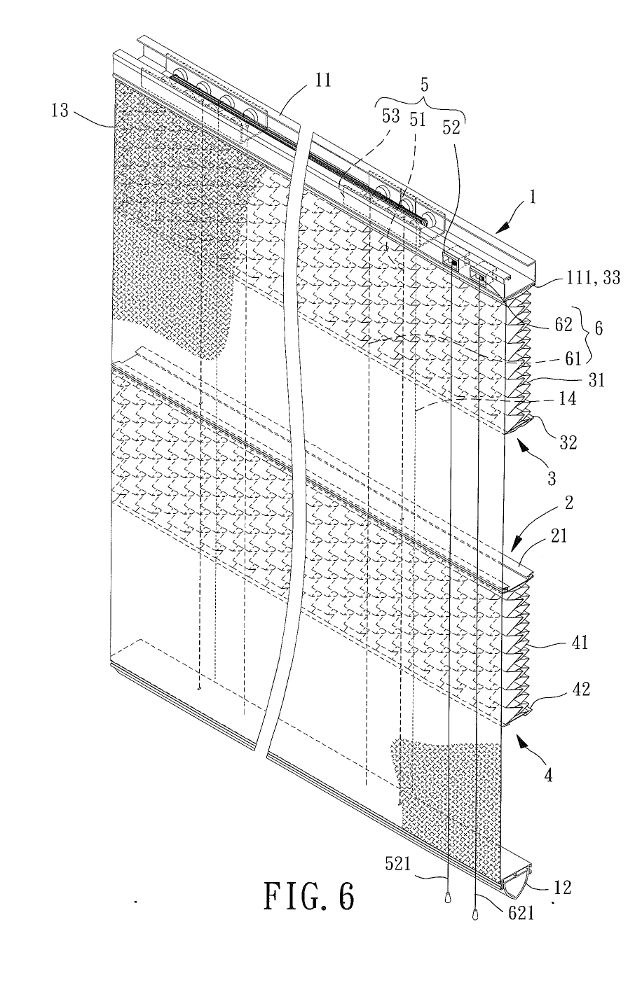

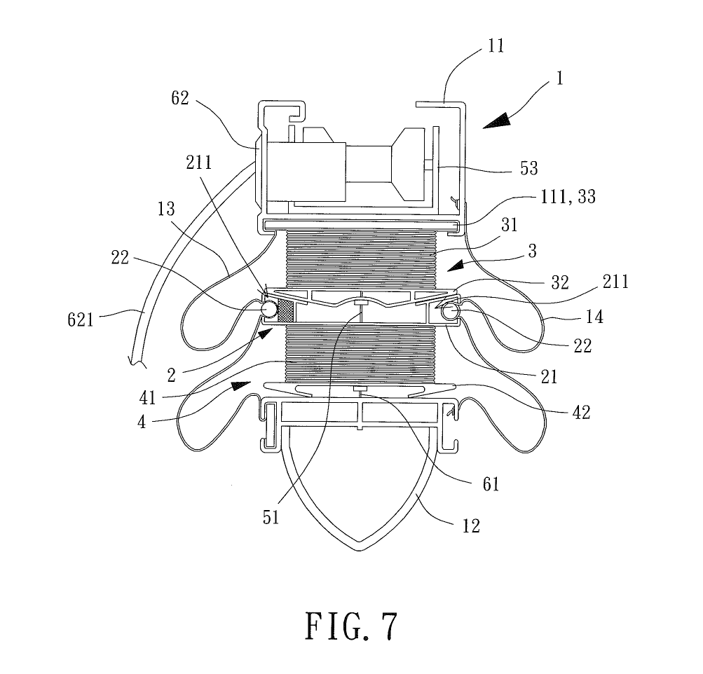

When the window shade is in a state shown in FIGS. 2 and 4 or in another state shown in FIGS. 5 and 6, if the second stringing member 61 of the full-scale adjustment module 6 is pulled, the lower track 12 is moved towards the upper track 11. During the upward movement of the lower track 12, the second weight 42, the partitioning plate 2, and the first weight 32 are also moved upwards. Thus, the second curtain body 41 and the first curtain body 31 are folded in sequence to permit the incoming light to enter the indoor space from below the lower track 12. In the state shown in FIG. 7, the first curtain 3 and the second curtain 4 are completely folded and are in a position closest to the upper track 11.

The window shade according to the present invention permits the user to easily fold the first weight 31 and the second weight 41 to the desired extent by the first stringing member 51, thereby adjusting of the amount of incoming light in different sections. Furthermore, the user can completely fold the window shade by the full-scale adjustment module 6 when more light is required or it is desired to increase the ventilation effect. Thus, the window shade according to the present invention provides more versatile usage statuses to meet different needs.

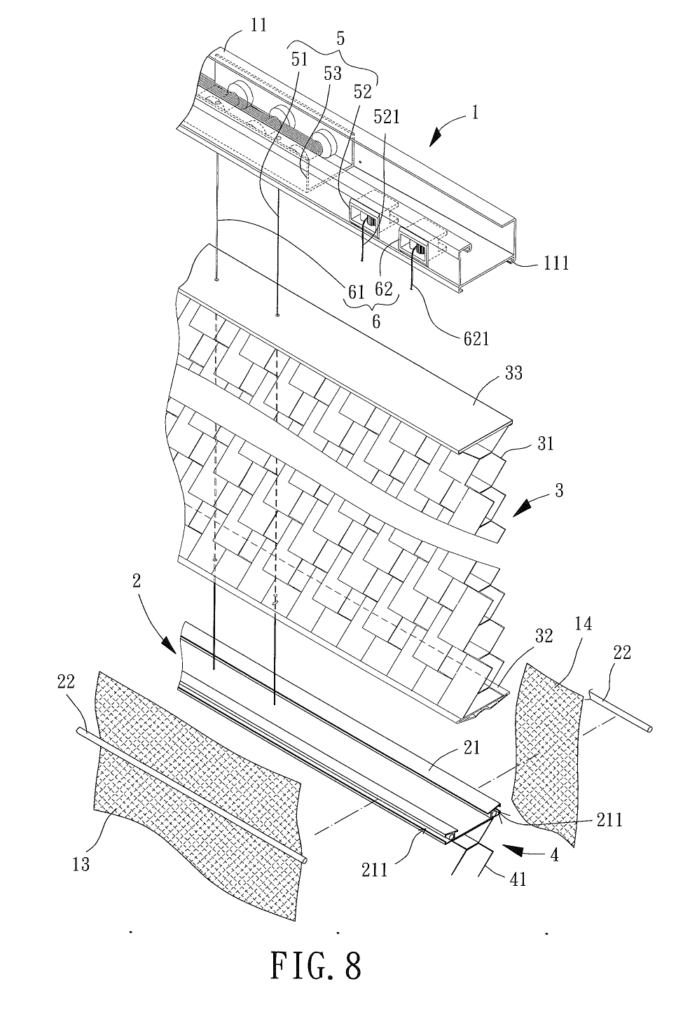

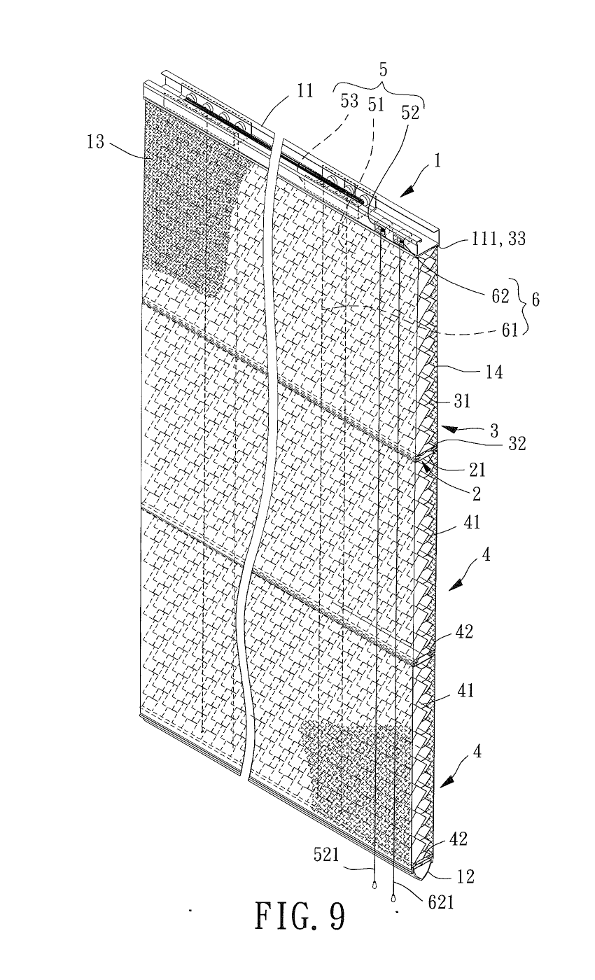

FIGS. 8 and 9 show a window shade allowing adjustment of the amount of incoming light in different sections of a second embodiment according to the present invention. The second embodiment is substantially the same as the first embodiment. The main differences are that the window shade of the second embodiment includes a plurality of partitioning plates 2 and a corresponding number of second curtains 4 to provide a multi-section light-transmission effect. Furthermore, the rear connecting member 14 is also a light-transmittable curtain to further enhance the use safety.

Specifically, each of the front connecting member 13 and the rear connecting member 14 strings the partitioning plates 2 to stably suspend the partitioning plates 2 between the upper track 11 and the lower track 12, with the partitioning plates 2 spaced from each other in the vertical direction. Each second curtain body 41 is located between two adjacent partitioning plates 2. Each second curtain body 41 includes two ends respectively connected to the second weight 42 and an upper one of the two adjacent partitioning plates 2. Folding and unfolding of each second curtain body 41 can be controlled to adjust of the amount of incoming light by adjusting each second curtain body 41 and the upper one of the two adjacent partitioning plates 2.

The first stringing member 51 of the separate adjustment module 5 includes a first end fixed in the speed changer 53. The first stringing member 51 strings the first weight 32 and each second weight 42. Thus, the first weight 32 and the second weights 42 can move synchronously. The first stringing member 51 further includes a second end fixed to the lowest second weight 42.

Furthermore, the second stringing member 61 of the full-scale adjustment module 6 has a first end fixed in the speed changer 53. The second stringing member 61 extends through the first weight 32, the partitioning plates 2, and each second weight 42. The second stringing member 61 further has a second end fixed to the lower track 12.

If the first stringing member 51 of the separate adjustment module 5 is pulled, the first weight 32 and each second weight 42 can synchronously be moved by the first stringing member 51. The first curtain body 31 and the second curtain bodies 42 are synchronously folded to provide a multi-section light-transmission effect.

On the other hand, if the second stringing member 61 of the full-scale adjustment module 6 is pulled to move the lower track 12 towards the upper track 11, the second weights 42, the partitioning plates 21, and the first weight 32 are also moved upwards during the upward movement of the lower track 12. Thus, the second curtain bodies 41 and the first curtain body 31 are folded in sequence to permit the incoming light to enter the indoor space from below the lower track 12.

In view of the foregoing, by the provision of the separate adjustment module 5 stringing the first and second weights 32 and 42, the window shade allowing adjustment of the amount of incoming light in different sections according to the present invention can control synchronous folding or unfolding of the first curtain 3 and the second curtain 4, achieving adjustment of the amount of incoming light in different sections. Thus, the window shade is simple in structure and is easy to manufacture to thereby reduce the manufacturing costs while increasing installation convenience to permit installation by the user himself.

The components of the window shade allowing adjustment of the amount of incoming light in different sections according to the present invention are simple and light, and no curtain support columns are required in the place requiring the light-shielding effect, permitting use of the window shade on a small-size window of a house.

Note either the dual-section light-transmittable window shade of the first embodiment or the multi-section light-transmittable window shade of the second embodiment, the front connecting member 13 and the rear connecting member 14 can be varied according to needs. For example, the rear connecting member 14 of the first embodiment can be a light-transmittable curtain. The rear connecting member 14 of the second embodiment can be a plurality of strings or of any other arrangements, which can be appreciated by a person having ordinary skill in the art. The present invention is not limited to the illustrated types.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A window shade comprising:
a track device including an upper track, a lower track, a front connecting member, and a rear connecting member, with the lower track located below the upper track, with the front connecting member including two ends respectively connected to the upper track and the lower track, with the rear connecting member including two ends respectively connected to the upper track and the lower track;
a partitioning plate mounted between the upper track and the lower track, with each of the front connecting member and the rear connecting member stringing the partitioning plate;
a first curtain including a first curtain body and a first weight, with the first curtain body including two ends respectively connected to the upper track and the first weight;
a second curtain including a second curtain body and a second weight, with the second curtain body including two ends respectively connected to the second weight and the partitioning plate; and
a separate adjustment module connected to the upper track, with the separate adjustment module stringing the first weight and the second weight, with the separate adjustment module adapted for simultaneously pulling the first weight and the second weight.

2. The window shade as claimed in claim 1, with the separate adjustment module including a first stringing member, a first controller, and a speed changer, with the first controller and the speed changer mounted in the upper track, with the first stringing member including a first end fixed in the speed changer, with the first stringing member stringing the first weight and the second weight, with the first stringing member further including a second end fixed to the second weight, with the first controller including a first follower having a first end indirectly connected to the first stringing member via the speed changer, and with the first follower further having a second end exposed outside of the upper track.

3. The window shade as claimed in claim 2, further comprising: a full-scale adjustment module including a second stringing member and a second controller, with the second stringing member having a first end fixed in the speed changer, with the second stringing member extending through the first weight, the partitioning plate, and the second weight, with the second stringing member further having a second end fixed to the lower track, with the second controller including a second follower having a first end indirectly connected to the second stringing member via the speed changer, and with the second follower further having a second end exposed outside of the upper track.

4. The window shade as claimed in claim 1, with the partitioning plate including a plate body having a first lateral side and a second lateral side opposite to the first lateral side, with the first lateral side having a first engagement groove facing the front connecting member, with the second lateral side having a second engagement groove facing the rear connecting member, with the front connecting member being a light-transmittable curtain, with a portion of the front connecting member inserted into the first engagement groove, and with a first fixing member mounted in the first engagement groove to fix the portion of the front connecting member in the first engagement groove.

5. The window shade as claimed in claim 4, with the rear connecting member being a light-transmittable curtain, with a portion of the rear connecting member inserted into the second engagement groove, with a second fixing member mounted in the second engagement groove to fix the portion of the rear connecting member in the second engagement groove.

6. The window shade as claimed in claim 1, with the upper track including a bottom having a coupling portion, with the first end of the first curtain body connected to a top plate, and with the top plate coupled with the coupling portion to connect the first curtain body to the upper track via the top plate.

7. A window shade comprising:
a track device including an upper track, a lower track, a front connecting member, and a rear connecting member, with the lower track located below the upper track in a vertical direction, with the front connecting member including two ends respectively connected to the upper track and the lower track, with the rear connecting member including two ends respectively connected to the upper track and the lower track;
a plurality of partitioning plates, with each of the front connecting member and the rear connecting member stringing the plurality of partitioning plates, with the plurality of partitioning plates spaced from each other in the vertical direction and mounted between the upper track and the lower track;
a first curtain including a first curtain body and a first weight, with the first curtain body including two ends respectively connected to the upper track and the first weight;
a plurality of second curtains, with each of the plurality of second curtains mounted between two adjacent partitioning plates, with each of the plurality of second curtains including a second curtain body and a second weight, with each second curtain body including two ends respectively connected to the second weight and an upper one of the two adjacent partitioning plates; and
a separate adjustment module connected to the upper track, with the separate adjustment module stringing the first weight and each second weight, with the separate adjustment module adapted for simultaneously pulling the first weight and each second weight.

8. The window shade as claimed in claim 7, with the separate adjustment module including a first stringing member, a first controller, and a speed changer, with the first controller and the speed changer mounted in the upper track, with the first stringing member including a first end fixed in the speed changer, with the first stringing member stringing the first weight and each second weight, with the first stringing member further including a second end fixed to a lowest one of the second weights, with the first controller including a first follower having a first end indirectly connected to the first stringing member via the speed changer, and with the first follower further having a second end exposed outside of the upper track.

9. The window shade as claimed in claim 8, further comprising: a full-scale adjustment module including a second stringing member and a second controller, with the second stringing member having a first end fixed in the speed changer, with the second stringing member extending through the first weight, the plurality of partitioning plates, and each second weight, with the second stringing member further having a second end fixed to the lower track, with the second controller including a second follower having a first end indirectly connected to the second stringing member via the speed changer, and with the second follower further having a second end exposed outside of the upper track.
